(19) United States
(12) Patent Application Publication
(10) Pub. No.: US 2014/0361901 A1
(43) Pub. Date: Dec. 11, 2014

(54) TOBACCO SMOKE DETECTOR, HAZARD DETECTOR, AND METHOD OF DISTINGUISHING TOBACCO SMOKE FROM FIRE SMOKE

(71) Applicant: SIEMENS AKTIENGESELLSCHAFT, Muenchen (DE)

(72) Inventor: ULRICH HOEFER, OBERWIL (CH)

(21) Appl. No.: 14/300,390

(22) Filed: Jun. 10, 2014

(30) Foreign Application Priority Data
Jun. 10, 2013 (EP) 13171261.4

(51) Int. Cl. G08B 17/10

(52) U.S. Cl. CPC G08B 17/10
USPC 340/628

(57) ABSTRACT

A tobacco smoke detector has a gas-sensitive semiconductor sensor device (in particular, GasFET sensor) with a first gas-sensitive layer which reacts to tobacco smoke and a second gas-sensitive layer which reacts to fire products. An evaluation unit (e.g. microchip) analyzes the signals supplied by the first and the second gas-sensitive layer and determines whether tobacco smoke is present. Optionally, the tobacco smoke detector contains an interface for providing a connection using signals or data technology to a hazard detector and/or a hazard control unit and/or an output device, in particular for transmitting information as to whether tobacco smoke is present. Optionally, the tobacco smoke detector can be operationally integrated into a conventional hazard detector (e.g. fire alarm).

### CROSS-REFERENCE TO RELATED APPLICATION

This application claims the priority, under 35 U.S.C. §119, of European application EP 13171261.4, filed Jun. 10, 2013; the prior application is herewith incorporated by reference in its entirety.

### BACKGROUND OF THE INVENTION

### Field of the Invention

The invention relates to a tobacco smoke detector for determining whether tobacco smoke is present. Furthermore, the invention relates to hazard detectors containing a tobacco smoke detector. In addition, the invention relates to a hazard warning system with hazard detectors and tobacco smoke detectors. Moreover, the invention relates to a method for differentiating between tobacco smoke and fire smoke.

For the protection of the non-smoking population, smoking is forbidden in most public establishments worldwide. In addition, smoking leads to odor nuisance, in particular in hotel rooms. In the event of contraventions, hotel rooms must be laboriously cleaned with ozonizers, giving rise to additional costs and annoyance. Furthermore, in places where smoking takes place nonetheless (rooms, corridors, halls), there is a latent risk of fire as on account of the smoking ban no corresponding facilities are provided for the disposal of ash and cigarette ends which are potentially still glowing. Making monitoring easier or early notification of a contravention of the smoking ban could ensure additional safety in precisely this area. In a hotel it can also spare the guest as well as the hotelier from unpleasantness.

Traditional fire alarms cannot distinguish between fire smoke and cigarette smoke and therefore continue tending to produce false alarms, i.e. a fire alarm is triggered as a result of the detection of cigarette smoke.

### SUMMARY OF THE INVENTION

It is therefore the task of the present invention to provide a smoke detector which can selectively detect tobacco smoke.

The object is achieved by a tobacco smoke detector, in particular for the detection of cigarette smoke. The tobacco smoke detector contains a gas-sensitive semiconductor sensor device with a first gas-sensitive layer which reacts to tobacco smoke and a second gas-sensitive layer which reacts to fire products. An evaluation unit is provided to analyze the signals supplied by the first and the second gas-sensitive layer and to determine whether tobacco smoke is present. An interface is provided for a connection by signals or data technology to a hazard detector and/or a hazard control unit and/or an output device, in particular for transmitting information as to whether tobacco smoke is present. The tobacco smoke detector constitutes a monitoring device which clearly identifies cigarette smoke in rooms or public buildings in good time and enables ad hoc appropriate measures to be taken. Thus, if a fire alarm usually present in every room or in public facilities anyway has such a tobacco smoke detector which selectively detects tobacco smoke and in particular cigarette smoke, it could be used for this purpose and assume the monitoring function. In the event of a fire it gives an alarm, in the event of cigarette smoke it sends an informative message to a central facility (e.g. hotel reception, hotel management system or janitor). The tobacco smoke detector can therefore be configured and/or operate as a separate tobacco smoke detector (in particular, cigarette smoke detector) independently of existing fire alarms or fire alarm control units. However, it is also possible to operate the tobacco smoke detector according to the invention with a traditional fire alarm or a fire alarm system or a fire alarm control unit. The tobacco smoke detector according to the invention enables the dedicated detection of tobacco smoke and its distinction from genuine fire phenomena. Thus, in particular, it is possible to issue messages differentiated accordingly.

The signals supplied from the first and the second gas-sensitive layers are based on the principle of a change in work function, change in conductivity or another transducer principle. Determining whether tobacco smoke is present takes place in the evaluation unit (e.g. a microchip) by analysis of the signal patterns supplied by the gas-sensitive layers.

Semiconductor gas sensors based on gas-sensitive field-effect transistors (GasFET) are small, relatively inexpensive to manufacture as a result of mass production and require less complex signal evaluation compared with traditional fire alarms. GasFETs are field-effect transistors with a source region, a channel region, a drain region and a gas-sensitive gate electrode.

Such a field effect transistor is realized as follows, for example: a trough-shaped source region and a trough-shaped drain region adjoin a channel region. These three regions are located on the surface of a base body and are protected via gate insulation. The gas-sensitive gate is at a defined distance from the gate insulation and/or the base body (“suspended gate”). The gate electrode is coated with a specific gas-sensitive material and separated from the active channel region by an air gap. Gaseous components reach the gap by diffusion. In the event of fire, flue gas molecules therefore also reach the gate region and interact with the gas-sensitive layer via adsorption or desorption mechanisms. The work function at the gate is altered by this interaction of the flue gas molecules with the gas-sensitive layer and results in an altered electrical potential which is superimposed on the applied gate voltage in an additive manner. The channel region is capacitively driven by this. At constant drain source voltage the alteration of channel conductance can, for example, be detected as an alteration of the drain current.

Such gas-sensitive field-effect transistors may have discrete, individual, gas-sensitive channels or may also combine several different channels in one chip (array). A first advantageous embodiment of the invention is that the first gas-sensitive layer has a TiN layer and/or a Pd layer and/or an Rh layer and/or a Pt layer. As gas-sensitive layers, TiN (titanium nitride; a compound of the chemical elements titanium and nitrogen), Pd (palladium), Rh (rhodium) and Pt (platinum) react to tobacco smoke with an alteration of the work function (e.g. measured in meV). TiN, Pd, Rh and Pt react to the ammonia (NH3) contained in tobacco smoke, wherein TiN reacts almost exclusively to ammonia.

A further advantageous embodiment of the invention is that the second gas-sensitive layer has a GaOx and/or a CuPC layer. Both GaOx (gallium oxide) and CuPC (copper phthalocynine) react to fire smoke, but not to tobacco smoke. For example, in the event of a paper fire, GasFETs with GaOx as well as CuPC layers react in a negative direction (in meV). The reason for this reaction is the N0₂ portion in the gaseous portion of the fire products. TiN has virtually no reaction to this.

Through the evaluation of the signals measured by the gas-sensitive layers, a differentiated and clear determination is therefore possible as to whether tobacco smoke or genuine fire smoke (e.g. paper fire) is present (provided that no other NH₃-emitting fuels are present).

A further advantageous embodiment of the invention is that the first gas-sensitive layer has a TiN layer and the second gas-sensitive layer a GaOx layer and/or a CuPC layer and/or a Pd layer and/or an Rh layer and/or a Pt layer.

However, there is a risk of confusion with genuine fires when only taking into account a single TiN layer due to the ammonia portion which may also occur in other specific fires (wool).

The exclusive use of the Pt layer does not enable any differentiated decision as to whether tobacco smoke or fire smoke is present either, as Pt reacts to both the ammonia in tobacco smoke as well as, in particular, to the N0₂ portion in the gaseous portion of fire products (measured in a negative direction in meV). As TiN has virtually no reaction to this, a differentiated and clear determination as to whether tobacco smoke or genuine fire smoke (e.g. paper fire) is present is also possible in this embodiment.

A further advantageous embodiment of the invention is that the tobacco smoke detector contains an output unit for the optical and/or acoustic output of a smoking ban instruction. The output unit may, for example, contain a loudspeaker which, when cigarette smoke is detected, emits a message of the following kind, “Please stop smoking”. However, the output unit may also be a graphic display from which a smoking ban message (textual and/or graphics) is also emitted. It is clear to the person skilled in the art that both an acoustic and a visual smoking ban instruction can be emitted simultaneously. Furthermore, when cigarette smoke is detected, a central control point (e.g. hotel management system) can also be informed in addition, advantageously with an indication of the location of the tobacco smoke detector.

A further advantageous embodiment of the invention is that when tobacco smoke is detected, the tobacco smoke detector takes corresponding ventilation measures in the area of the space in which the tobacco smoke detector is located. In the corresponding room e.g. the ventilation can be activated or a window opened, weather permitting. The odor nuisance is kept to a minimum by these ventilation measures and in addition the smoker is made aware of his inappropriate behavior.

A further advantageous embodiment of the invention is that the tobacco smoke detector is integrated into a hazard detector for the detection of hazards in a building. No additional assembly need be undertaken as a result of the combination or integration of fire and tobacco smoke detectors. Nor is a space visually overloaded with hazard detectors.

The object is furthermore achieved by a hazard detector, in particular a point detector, for the detection of hazardous situations in a building, containing a tobacco smoke detector according to the invention. No additional assembly need be undertaken as a result of the combination or integration of hazard detectors and tobacco smoke detectors. In addition, it is ensured that the hazard detector does not emit a false alarm on account of cigarette smoke.

A further advantageous embodiment of the invention is that the hazard detector is a fire alarm with an optical measuring chamber. Optical fire or smoke detectors have a detector unit (optical measuring chamber) which operates according to the scatter principle for the detection of smoke particles. Alternatively or in addition, optical fire or smoke detectors may have a detector unit which operates according to the acousto-optic principle and/or one or more gas sensors for the detection of gases typical of fires. As a result of this, the failsafe performance of the hazard detector is increased and furthermore a number of fire parameters are recorded.

The object is furthermore achieved by a hazard warning system with an alarm control unit, a detector circuit to which the alarm control unit and hazard detector, in particular fire detector, are connected. At least one tobacco smoke detector according to the invention is connected to the detector circuit in addition to the hazard detectors. At least one tobacco smoke detector is assigned an additional control unit which is equipped to analyze signals from one or more tobacco smoke detectors and in addition is equipped, based on the signals, to initiate appropriate measures in the area of a space in which a tobacco smoke detector issuing a signal is located.

Such hazard warning systems may in particular be fire alarm systems with a fire alarm control unit and fire alarms and/or tobacco smoke detectors connected to a bus forming the detector circuit, and a hotel management system connected to the bus. For fire alarm systems it was not permitted to operate other devices on the detector circuit until now because it was feared that the function of the fire alarm system might be impaired by these other devices. It was feared that in the event of an alarm so many messages might be sent that the bus would be blocked and the fire alarms could no longer send their alarm messages. But nowadays detector circuits are robust and with a bandwidth design that enables even worst-case scenarios such as e.g. message bursts to be processed. Cabling expenditure is reduced as a result of the alarm control unit and the additional control unit (e.g. hotel management system or hotel reception) and the individual detectors communicating by a single detector circuit.

Among other things, the hazard warning system according to the invention enables the interaction of safety-related and non-safety-related devices on a bus with a fire alarm control unit and an additional (non-safety-related) control unit (e.g. hotel management system).

A further advantageous embodiment of the invention is that communication between the hazard detectors and the alarm control unit and communication between the tobacco smoke detectors and the additional control unit takes place in different time slots. This ensures that smooth simultaneous operation of hazard detectors (e.g. fire alarms) and other devices such as e.g. tobacco smoke detectors is possible on the detector circuit.

A further advantageous embodiment of the invention is that means are provided for the optional connection of the detector circuit to one of the two control units. The connection of the detector circuit to one of the control units preferably takes place by a switching device controlled by the alarm control unit (e.g. by a monitor, locking or semaphore mechanism).

A further advantageous embodiment of the invention is that means of prioritizing the messages from the hazard detectors and of suppressing the switching of the detector circuit to the additional control unit are provided. The messages from hazard detectors are preferably prioritized and suppress the switching of the detector circuit to at least one additional control unit. Messages from a hazard detector may e.g. contain a priority bit which is requested and detected by the detector circuit. When a priority bit is detected, the detector circuit suppresses the switching of messages from the other devices (e.g. tobacco smoke detectors).

It is also possible that messages from hazard detectors are prioritized and the switching of messages from the other devices is suppressed by a synchronization mechanism (e.g. with semaphores, locking or monitors).

A further advantageous embodiment of the invention is that the appropriate measures to be taken involve the issue of a smoking ban instruction and/or a corresponding ventilation measure. For example, the ventilation may be activated automatically or a window opened in the corresponding room when tobacco smoke is detected. The odor nuisance is kept to a minimum by means of these ventilation measures and in addition the smoker is made aware of his inappropriate behavior.

A further advantageous embodiment of the invention is that the additional control unit is a hotel management system. Measures may be taken directly by the hotel management system, such as e.g. notification of cleaning personnel that special ventilation or ozonization is necessary in the corresponding rooms. Another measure would be e.g. to send hotel staff to point out the smoking ban.

In addition, the object is achieved by a method for distinguishing tobacco smoke and fire smoke, wherein signals from a first gas-sensitive coating which reacts to tobacco smoke are recorded. In addition signals from a second gas-sensitive coating which reacts to fire are recorded. Based on the signal patterns supplied by the first and the second gas-sensitive coating, an evaluation unit determines whether tobacco smoke and/or fire smoke is present. The first gas-sensitive coating reacts to ammonia, and the second gas-sensitive coating also reacts to other combustion gas components.

The signals supplied by the first and the second gas-sensitive layer are based on the principle of a change in work function, a change in conductivity or another transducer principle. Determination as to whether tobacco smoke is present takes place in the evaluation unit (e.g. a microchip) by analysis of the signal patterns supplied by the gas-sensitive layers. The analysis takes place in the evaluation unit by means of corresponding software or firmware.

A further advantageous embodiment of the invention is that the first gas-sensitive coating contains a TiN layer and the second gas-sensitive coating is formed by a layer of organic porphin pigments and/or a layer of organic polymers and/or inorganic substances. The TiN layer reacts to ammonia (NH₃) which is released by tobacco smoke. However, an ammonia portion is also released in the case of fires involving wool. The second gas-sensitive coating reacts to gases which are released in a fire. By evaluating the signals supplied by the first and the second gas-sensitive coating, it is possible to make a differentiated decision as to whether tobacco smoke (i.e. no immediate danger) or fire smoke (immediate danger) is present.

The organic porphin pigments may be e.g. phthalocyanines (e.g. CuPC copper phthalocyanine), porphyrines or cobyrinates. The organic polymers may be e.g. polysiloxanes, polycarbonates or polyimides. The inorganic substances may be e.g. oxides, carbonates, phosphates, halides or metals.

A further advantageous embodiment of the invention is that the inorganic substances may be oxides and/or carbonates and/or phosphates and/or halides and/or metals.

A further advantageous embodiment of the invention is that the metals concerned are platinum and/or palladium and/or gold and/or nickel and/or rhodium.

The gas-sensitive layers are usually realized as GasFET sensor layers in semiconductor gas sensors, wherein a semiconductor gas sensor may contain one or more gas-sensitive layers. However, it is also possible to use several semiconductor gas sensors which may each comprise one or more gas-sensitive layers.

Other features which are considered as characteristic for the invention are set forth in the appended claims.

Although the invention is illustrated and described herein as embodied in a tobacco smoke detector, hazard detector, and method of distinguishing tobacco smoke from fire smoke it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of an exemplary tobacco smoke detector according to the invention, connected to a detector circuit;

FIG. 2 is a block diagram of a second exemplary tobacco smoke detector according to the invention, connected to the detector circuit;

FIG. 3 is a perspective view of a third exemplary tobacco smoke detector according to the invention with an output device on a detector vertex;

FIG. 4 is a block diagram of an exemplary hazard detector with an integrated tobacco smoke detector according to the invention, connected to the detector circuit;

FIG. 5 is a block diagram of an exemplary hazard warning system with the tobacco smoke detectors and the hazard detectors connected to the detector circuit, and a fire alarm control unit and an additional control unit;

FIG. 6 is an exemplary diagram which shows a reaction of different (GasFET) sensor layers to tobacco smoke;

FIG. 7 is an exemplary diagram which shows the reaction of different (GasFET) sensor layers in a paper fire;

FIG. 8 is an exemplary diagram which represents the reaction of different (GasFET) sensor layers in a typical smoldering wood fire;

FIG. 9 is a block diagram of an exemplary diagram with signal patterns from different (GasFET) sensor layers and a conventional fire alarm for distinguishing tobacco smoke from a genuine fire; and

FIG. 10 is an exemplary flow chart for a method according to the invention.

### DETAILED DESCRIPTION OF THE INVENTION

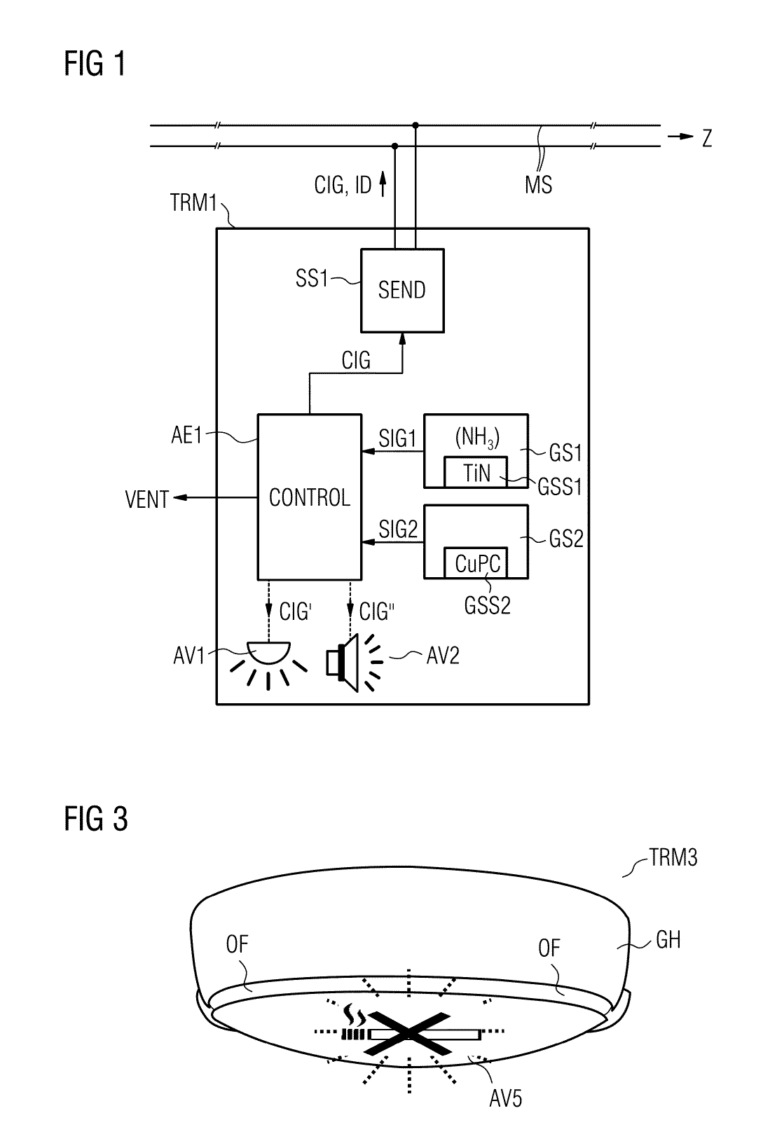

Referring now to the figures of the drawings in detail and first, particularly to FIG. 1 thereof, there is shown a first exemplary tobacco smoke detector TRM1 according to the invention, connected to a detector circuit MS. The tobacco smoke detector TRM1 is connected to a control center Z (e.g. a fire alarm control unit or a hotel management system) via the detector circuit MS. Additional detectors (hazard detectors, such as e.g. fire alarms and/or additional tobacco smoke detectors TRM1) are usually found on the detector circuit MS.

The exemplary tobacco smoke detector TRM1 according to the representation in FIG. 1 contains a first gas-sensitive semiconductor sensor device GS1 with a gas-sensitive layer GSS1 which reacts to tobacco smoke. In the exemplary tobacco smoke detector TRM1, by way of example a TiN layer is used (titanium nitride; compound of the chemical elements titanium and nitrogen) as a gas-sensitive layer GSS1 which reacts to tobacco smoke. In addition, the exemplary tobacco smoke detector TRM1 contains a second gas-sensitive semiconductor sensor device GS2 with a gas-sensitive layer GSS2 which reacts to fire products. In an exemplary fashion, the second gas-sensitive semiconductor sensor device GS2 contains a CuPC layer (copper phthalocyanine) as a gas-sensitive layer GSS2 which reacts to fire products. Another appropriate coating such as e.g. a GaOx layer (gallium oxide) could also be used as a gas-sensitive layer GSS2 which reacts to fire products.

Each of the gas-sensitive semiconductor sensor devices GS1 and/or GS2 may contain one or more appropriate gas-sensitive layers GSS1 or GSS2 respectively. The exemplary tobacco smoke detector TRM1 according to the representation in FIG. 1 contains two semiconductor sensor devices GS1 and GS2. However, it is also possible for a tobacco smoke detector TRM1 to only contain one semiconductor sensor device GS1, wherein this one semiconductor sensor device GS1 contains the gas-sensitive layers GSS1 (for tobacco smoke detection) and GSS2 (for fire detection). In the embodiment with two semiconductor sensor devices GS1 and GS2 as well, these may each comprise several gas-sensitive layers GSS1 (for tobacco smoke detection) and GSS2 (for fire detection).

In addition, the exemplary tobacco smoke detector TRM1 according to the representation in FIG. 1 contains an evaluation unit AE1 (CONTROL) to analyze the signals SIG1 and SIG2 supplied by the first and the second semiconductor sensor devices GS1, GS2 respectively and to determine whether tobacco smoke is present. The signals SIG1 and SIG2 supplied by the gas-sensitive layers GSS1 and GSS2 are based on the principle of a change in work function, a change in conductivity or another transducer principle. Determination as to whether tobacco smoke is present takes place in the evaluation unit AE1 (e.g. a microchip) by analysis of the signal patterns supplied by the gas-sensitive layers GSS1, GSS2. The analysis takes place in the evaluation unit AE1 by corresponding software or firmware.

In addition, the exemplary tobacco smoke detector TRM1 contains an interface SS1 for connection using signals or data technology to a hazard detector and/or a hazard control unit and/or an output device, in particular for the transmission of information CIG as to whether tobacco smoke is present. Connection using signals or data technology to a hazard detector and/or a hazard control unit and/or an output device takes place by the connection of the interface (SEND) SS1 to the detector circuit MS. The information CIG indicates that tobacco smoke was detected, while the identification signal ID indicates the tobacco smoke detector TRM1 from which the signal CIG is issued. Based on this information, at the central point Z (e.g. hotel management system, hotel reception), dedicated measures can be taken in the area of the corresponding tobacco smoke detector TRM1 (e.g. instruction of personnel to carry out an inspection). Based on the identification signal ID, the location of the tobacco smoke detector TRM1 can be easily ascertained in the control unit Z.

However, it is also possible that measures are taken autonomously by the evaluation unit AE1 of the tobacco smoke detector TRM1, based on the analysis of the signal patterns supplied by the gas-sensitive layers GSS1, GSS2. Thus, a dedicated ventilation measure (e.g. opening a window, activation of ventilation) can be taken e.g. by issuing a ventilation signal VENT for the space in which the tobacco smoke detector TRM1 is located. In addition, an output device AV1, AV2 can also be activated autonomously by the evaluation unit AE1 of the tobacco smoke detector TRM1. In FIG. 1 an optical output device AV1 for the output of a light or optical signal and an acoustic output device AV1 (loudspeaker) for the output of a sound and/or an announcement (e.g. output of a message text) are provided as output devices AV1, AV2 by way of an example. The output devices AV1, AV2 are controlled by the corresponding signal CIG′ or CIG″.

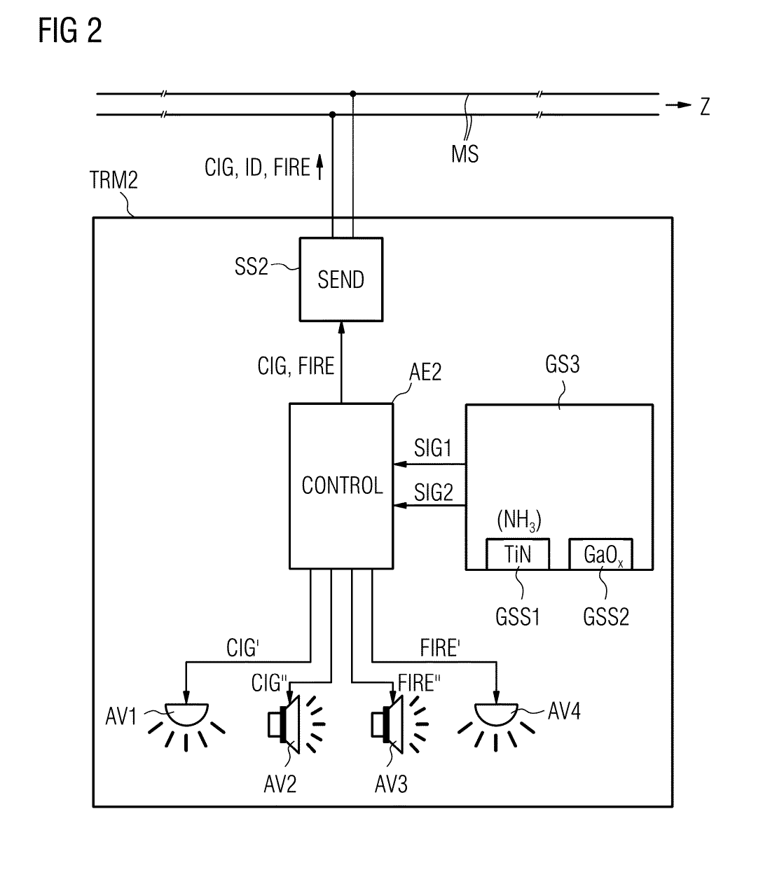

FIG. 2 shows a second exemplary tobacco smoke detector TRM2 according to the invention, connected to a detector circuit MS. The exemplary tobacco smoke detector TRM2 is connected to a central control center Z via the detector circuit MS. The exemplary tobacco smoke detector TRM 2 in accordance with FIG. 2 contains a gas-sensitive semiconductor sensor device GS3 (gas sensor) with a first gas-sensitive layer GSS1 which reacts to tobacco smoke and a second gas-sensitive layer GSS2, which reacts to fire products. In an exemplary fashion, a TiN layer is used in the gas sensor GS3 as a first gas-sensitive layer GSS1 which reacts to tobacco smoke. Titanium nitride reacts to the ammonia released by tobacco smoke (cigarette smoke, tobacco smoke, etc.), e.g. in the form of a change in work function which is forwarded via the signal SIG1 to the evaluation unit AE2 and analyzed there. In principle, another layer which reacts to tobacco smoke can also be used as a gas-sensitive layer GSS1, such as e.g. Pd (palladium) or Rh (rhodium). In principle, the gas sensor GS3 may also contain several layers which react to tobacco smoke.

In the representation according to FIG. 2, the exemplary gas-sensitive semiconductor sensor device GS3 (gas sensor) contains an exemplary GaOx layer (gallium oxide) as a second gas-sensitive layer GSS2 which reacts to fire products. In principle, another layer which reacts to fire products (e.g. fire smoke) can also be used as a gas-sensitive layer GSS2, such as e.g. CuPC (copper phthalocyanine). In principle, the gas sensor GS3 may also contain several layers which react to fire products. The fire signals SIG2 recorded by the gas-sensitive layer GSS2, e.g. in the form of work function, are forwarded to the evaluation unit (CONTROL) AE2 and analyzed there. In the evaluation unit AE2 (e.g. a microchip), the signals SIG1 and SIG2 supplied by the first GSS1 and the second gas-sensitive layer GSS2 are recorded and it is determined whether tobacco smoke CIG or fire FIRE is present by comparing the respective signal patterns over time.

The tobacco smoke detector TRM2 contains an interface (SEND) SS2 for connection using signals or data technology to a hazard detector and/or a hazard control unit Z and/or an output device, in particular for transmitting information as to whether tobacco smoke CIG or a detected fire parameter FIRE is present. Via the identification signal ID, the central point Z (hazard control unit, fire alarm control unit, hotel management system, etc.) detects the detector TRM2 from which such a signal CIG or FIRE is issued and can take corresponding measures in the surroundings of the detector TRM2 (e.g. output of warning signals).

However, when tobacco smoke CIG′, CIG″ or fire smoke FIRE′, FIRE″ is present, local output devices AV1-AV4 (e.g. flashing lights, loudspeakers) can be correspondingly triggered and activated by the evaluation unit AE2.

In principle, the gas-sensitive layers GSS1 and GSS2 can also be accommodated in separate respective gas sensors.

FIG. 3 shows a third exemplary tobacco smoke detector TRM3 according to the invention with an output device AV5 on the detector vertex. The exemplary tobacco smoke detector TRM3 contains a housing GH (e.g. of plastic) with openings OF through which the smoke can reach the gas-sensitive layers. In the exemplary tobacco smoke detector TRM3, a display for the optical output of a smoking ban instruction (e.g. as a flashing light) directly affixed to the detector vertex of the tobacco smoke detector TRM3 is provided as an exemplary output device AV5. The tobacco smoke detector TRM3 therefore contains an output device AV5 attached to or in the housing GH. This compact design makes assembly easier, in particular by saving in terms of cabling.

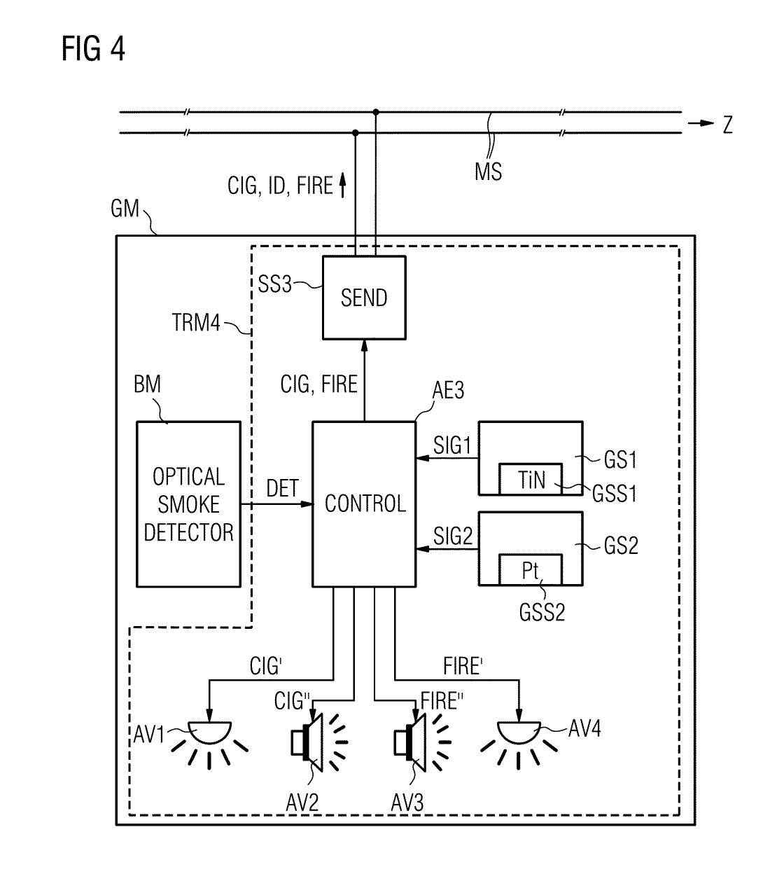

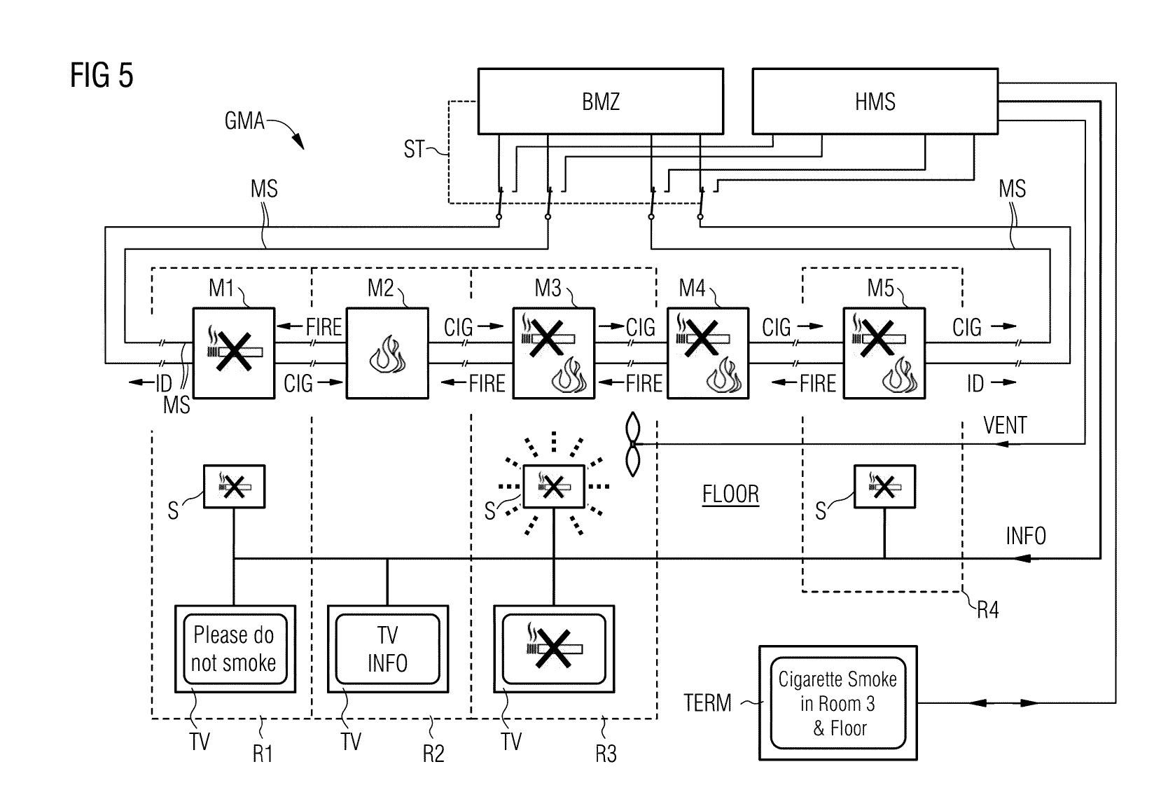

FIG. 4 shows an exemplary hazard detector GM (e.g. fire alarm) with an integrated tobacco smoke detector TRM4 according to the invention, connected to a detector circuit MS. The hazard detector GM is connected to a central point Z (e.g. fire alarm control unit) via the detector circuit MS. The hazard detector GM according to FIG. 4 contains a tobacco smoke detector TRM4 for the detection of tobacco smoke and a fire or smoke detector BM for the detection of fire parameters. The fire or smoke detector (OPTICAL SMOKE DETECTOR) BM may be e.g. an optical fire or smoke detector. Optical fire or smoke detectors have an optical detector unit (optical measuring chamber) which operates according to the scatter principle for the detection of smoke particles.

By combining or integrating hazard detectors GM and tobacco smoke detectors TRM4, no additional assembly need be undertaken. In addition, it is ensured that the hazard detector GM does not emit a false alarm on account of cigarette smoke. In addition, by integrating fire alarms BM and tobacco smoke detectors TRM4 the failsafe performance of the hazard detector GM is increased and in addition, a number of fire parameters are recorded. In particular, this increases the reliable detection of hazards.

The exemplary tobacco smoke detector TRM4 according to the representation in FIG. 4 contains a first gas-sensitive semiconductor sensor device GS1 with a gas-sensitive layer GSS1 which reacts to tobacco smoke. In the exemplary tobacco smoke detector TRM4, by way of example a TiN layer is used as a gas-sensitive layer GSS1 which reacts to tobacco smoke.

In addition, the exemplary tobacco smoke detector TRM4 contains a second gas-sensitive semiconductor sensor device GS2 with a gas-sensitive layer GSS2 which reacts to fire products. In an exemplary fashion, the second gas-sensitive semiconductor sensor device GS2 contains a Pt layer (platinum) as a gas-sensitive layer GSS2 which reacts to fire products.

Titanium nitride and platinum both react to the ammonia portion released by tobacco smoke. However, as titanium nitride virtually only reacts to ammonia and platinum also reacts to combustion smoke gases, when using these chemical elements as gas-sensitive layers GSS1 and GSS2, by analyzing the signal patterns SIG1 and SIG2 it can also be ascertained by the evaluation unit (CONTROL) AE3 whether tobacco or fire smoke is present. On receiving the message as to whether tobacco smoke CIG or a fire FIRE is present, the evaluation unit AE3 can also assess the signal DET of the fire alarm BM. Detected tobacco smoke signals CIG or fire signals FIRE can be reported via the interface (SEND) SS3 and via the detector circuit MS to a central point Z (e.g. safety-related fire alarm control unit and/or e.g. non-safety-related hotel management system). Optionally, when tobacco smoke and/or fire are detected, local devices AV1 to AV4 can also be activated by the evaluation unit AE3.

Each of the gas-sensitive semiconductor sensor devices GS1 and/or GS2 may comprise one or more appropriate gas-sensitive layers GSS1 and/or GSS2 respectively. The exemplary tobacco smoke detector TRM4 according to the representation in FIG. 4 contains two semiconductor sensor devices GS1 and/or GS2. However, it is also possible for a tobacco smoke detector TRM4 to only contain one semiconductor sensor device GS1, GS1, wherein this one semiconductor sensor device GS1, GS2 contains the gas-sensitive layers GSS1 (for tobacco smoke detection) and GSS2 (for fire detection).

The embodiment of the exemplary hazard detector GM according to FIG. 4 with an integrated tobacco smoke detector TRM4 according to the invention and fire alarm BM enables, inter alia, the easy assembly of tobacco smoke detectors TRM4 and fire alarms BM in a housing of the hazard detector GM.

FIG. 5 shows an exemplary hazard detection system GMA with an alarm control unit BMZ (e.g. fire alarm control unit), a detector circuit MS to which the alarm control unit BMZ and hazard detectors M2 to M5, in particular fire alarms, are connected, wherein in addition to the hazard detectors at least one tobacco smoke detector M1 according to the invention is connected to this detector circuit MS, wherein the at least one tobacco smoke detector M1 is assigned an additional control unit HMS which is equipped to analyze signals from one or more tobacco smoke hazard detectors M1 and in addition is equipped, based on the signals, to initiate appropriate measures in the area of a space R1 to R4 in which a tobacco smoke detector M1 issuing a signal is located. A tobacco smoke detector according to the invention can also be integrated into a hazard detector with a fire alarm. In FIG. 5 represented by the symbol (“smoking ban sign” and “fire symbol”) on the detectors M3 to M5. The spaces R1 to R4 in which the respective detectors M1 to M5 and corresponding output devices S, TV are located are represented by dotted lines.

Such hazard detection systems GMA may in particular be fire alarm systems with a fire alarm control unit BMZ and fire alarms and/or tobacco smoke detectors M1 to M5 connected to a bus forming the detector circuit MS, and a hotel management system HMS connected to the bus. In the case of fire alarm systems, until now it was not permitted to operate other devices on the detector circuit MS in addition because it was feared that the functioning of the fire alarm system might be impaired by these other devices. However, nowadays the detector circuits MS are robust and with a bandwidth design that enables even worst-case scenarios such as e.g. message bursts to be handled. As a result of the alarm control unit BMZ and the additional control unit HMS (e.g. hotel management system or hotel reception) and the individual detectors M1 to M5 communicating by means of a single detector circuit MS, cabling is reduced.

The hazard detection system GMA according to the invention enables, inter alia, the interaction of safety-related (hazard detectors with or without tobacco smoke detectors) and non-safety-related devices (e.g. pure tobacco smoke detectors) M1 on a bus MS with a fire alarm control unit BMZ and an additional (non-safety-related) control unit HMS (e.g. hotel management system).

A control line ST (preferably controlled by the safety-related fire alarm control unit BMZ as the master) ensures that communication between the hazard detectors and the alarm control unit BMZ and communication between the tobacco smoke detectors and the additional control unit HMS takes place in different time slots. This ensures that smooth simultaneous operation of hazard detectors (e.g. fire alarms) and other devices such as e.g. tobacco smoke detectors is possible on the detector circuit MS.

Means for the optional switching of the detector circuit MS are advantageously provided on one of the two control units BMZ, HMS. Switching of the detector circuit MS to one of the control units BMZ, HMS preferably takes place by a switching device controlled by the alarm control unit BMZ (e.g. by means of a monitor, locking or semaphore mechanism).

Means of prioritizing the messages from the hazard detectors and of suppressing the switching of the detector circuit MS to the additional control unit HMS are advantageously provided. Messages from hazard detectors are preferably prioritized and suppress switching of the detector circuit MS to the at least one other additional control unit HMS. Messages from a hazard detector may e.g. contain a priority bit which is requested and detected by the detector circuit MS. When a priority bit is detected, the detector circuit MS and/or the fire alarm control unit BMZ suppresses the switching of messages from the other devices (e.g. tobacco smoke detectors).

It is also possible that messages from hazard detectors are prioritized and the switching of messages from the other devices is suppressed by a synchronization mechanism (e.g. with semaphores, locking or monitors).

The additional control unit HMS advantageously involves a hotel management system. Measures can be taken directly by the hotel management system HMS such as e.g. notification of cleaning staff that special ventilation or ozonization is necessary in the corresponding rooms R1 to R4. Another measure would be e.g. to send hotel staff to point out the smoking ban.

The appropriate measures to be taken advantageously involve the issue of a smoking ban instruction and/or a corresponding ventilation measure. When tobacco smoke is detected the ventilation (signal VENT) can be automatically activated or a window opened, for example, in the corresponding room R1 to R4. The odor nuisance is reduced by these ventilation measures and in addition, the smoker is made aware of his inappropriate behavior.

Where there is corresponding detection, the detectors M1 to M5 transmit corresponding signals CIG (tobacco smoke was detected) or FIRE (a fire parameter was detected) via the detector circuit MS to one or to both control units BMZ and/or HMS, wherein it must be ensured that fire signals FIRE are always treated as a priority and are always transmitted to the fire alarm control unit as a priority.

The output devices in FIG. 5 are, for example, television monitors TV (which may already be found in a hotel room anyway) and/or terminals TERM, signs S affixed in the room and/or in the corridor, on which textual instructions (e.g. “Please do not smoke” or “Cigarette Smoke in Room 3 & Corridor” or pictograms (e.g. a no-smoking sign) are displayed. By the identification number ID assigned to a detector M1 to M5, appropriate measures can be taken in a dedicated manner by the control units BMZ, HMS in the respective space R1 to R4 in which a respective hazard detector M1 to M5 is located.

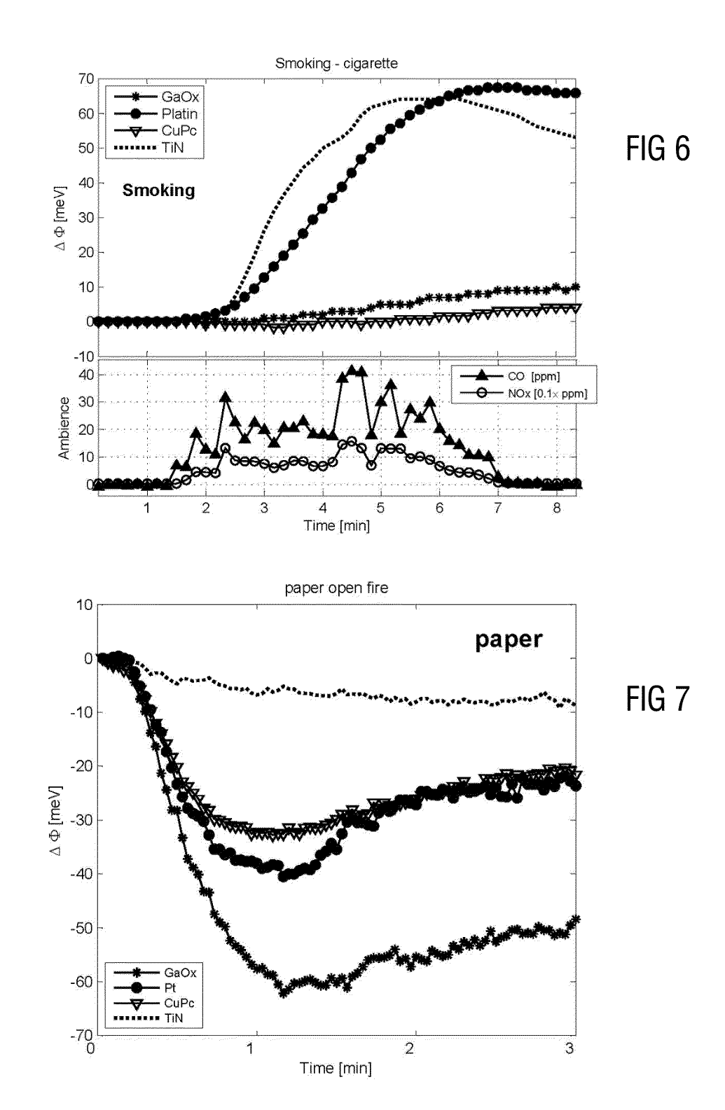

FIG. 6 shows an exemplary diagram which represents the reaction of four different gas-sensitive (GasFET) sensor layers (GaOx, platinum, CuPC, TiN) to tobacco smoke (“Smoking—cigarette). In the diagram according to FIG. 6 the time is shown on the horizontal axis and the reaction of the corresponding gas-sensitive layer on the perpendicular axis. In the diagram according to FIG. 6 the reaction in the measured work function is represented in meV.

While TiN (titanium nitride) and Pt (platinum) in particular display strong positive signals, the CuPc layer (copper phthalocyanine) and the GaOx layer (gallium oxide) in particular do not react to tobacco smoke.

The reactions for TiN (titanium nitride) and Pt (platinum) are typical for tobacco smoke (e.g. cigarette smoke) but also for burning wool, as both layers react to the respective ammonia (NH3) contained. The TiN layer virtually only reacts to ammonia. The aim now is to detect tobacco smoke in good time and to distinguish it as clearly as possible from a genuine fire with a hazard detector equipped with such gas-sensitive sensors (in particular, semiconductor sensors). This may be difficult on account of the ammonia portion in fires involving wool as there would be a risk of confusion if only the TiN layer were to be used for evaluation. The solution is to include a second gas-sensitive layer, which reacts to fire products, for evaluation. This additional layer may be e.g. platinum (Pt) and/or copper phthalocyanine (CuPC). This also ensures the detection of a genuine fire.

The diagram according to FIG. 6 consists of an upper and a lower section. In the upper section the time is shown on the horizontal axis and the reaction of the corresponding gas-sensitive layers on the perpendicular axis. In the diagram according to FIG. 6, the reaction is shown in the measured work function in meV.

In the lower section of FIG. 6 the time is also shown on the horizontal axis and on the perpendicular axis the corresponding environmental conditions (ambience, gas concentration) as regards CO and NOx. The gas concentration for CO is specified in [ppm] (parts per million), that for NOx (nitrogen oxide) in [0.1×ppm].

FIG. 7 shows an exemplary diagram which shows the respective reaction of the (GasFET) sensor layers (GaOx, platinum, CuPC, TiN) also used in FIG. 6 in a paper fire (paper open fire). In the diagram according to FIG. 7, the time is shown on the horizontal axis and the reaction of the corresponding gas-sensitive layer on the perpendicular axis. In the diagram according to FIG. 7 too, the reaction in the measured work function is shown in meV. The reactions of the Pt, GaOx and CuPC layers in a negative direction are clearly discernible. The reason for these reactions is the NO₂ portion in the gaseous portion of the fire products. The TiN layer has virtually no reaction to this.

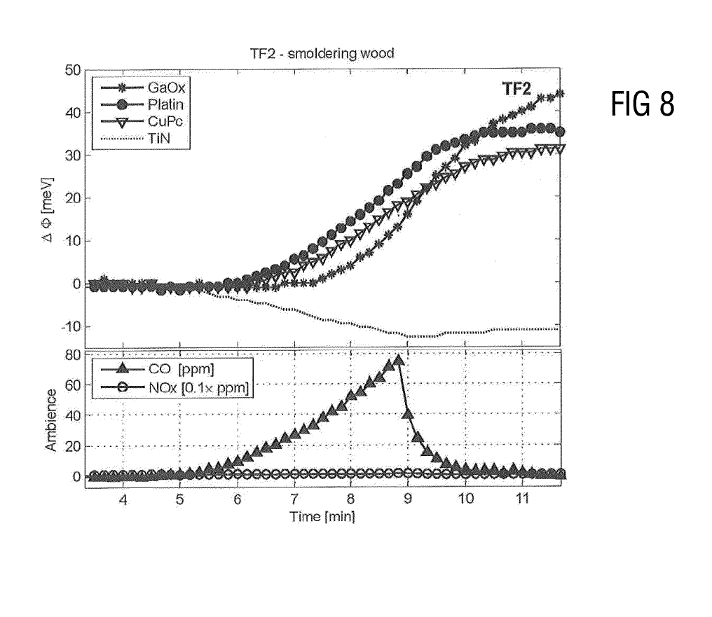

FIG. 8 shows an exemplary diagram which represents the reaction of different (GasFET) sensor layers (GaOx, platinum, CuPC, TiN) in a typical smoldering wood fire. On account of incomplete combustion in a smoldering fire, mainly CO (carbon oxide) is produced. The Pt, GaOx and CuPC layers have a positive reaction here. Only the TiN layer has virtually no reaction here either.

As the CuPC layer has only a slight reaction to tobacco smoke (not shown here) or none at all, at least tobacco smoke can be detected in this way.

The exclusion of smoldering sheep's wool is not possible with certainty in the initial phase—but if the sheep's wool burns with an open flame, this can in turn be clearly established via the NO₂ portion (reaction of CuPC).

The diagram according to FIG. 8 consists of an upper and a lower section. In the upper section the time is shown on the horizontal axis and on the perpendicular axis the reaction of the corresponding gas-sensitive layers. In the diagram according to FIG. 8 the reaction is also shown in the measured work function in meV.

In the lower section of FIG. 8 the time is also shown on the horizontal axis and on the perpendicular axis the corresponding environmental conditions (ambience, gas concentration) as regards CO and NOx. The gas concentration for CO is specified in [ppm] (parts per million), that for NOx (nitrogen oxide) in [0.1×ppm].

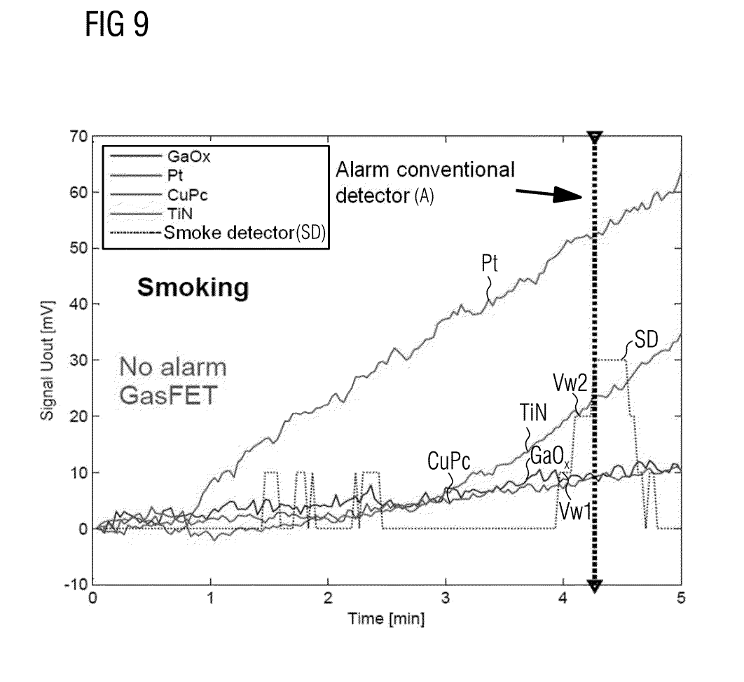

FIG. 9 shows an exemplary diagram with signal patterns from different (GasFET) sensor layers (GaOx, platinum, CuPC, TiN) and a conventional fire alarm SD (smoke detector) for distinguishing tobacco smoke (smoking) from a genuine fire. The representation according to FIG. 9 shows the signal or the signal pattern of the tobacco smoke detector according to the invention compared with a conventional optical smoke detector (SD). The time is plotted on the X-axis while the signal (Uout in mV) of the respective layers is plotted on the Y-axis.

From minute 3 the signal from the TiN layer of the gas-sensitive field-effect transistor forming the basis of the tobacco smoke detector also increases due to the ammonia portion of the tobacco smoke. The signal of the Pt layer also increases but that of the other layers (CuPC, GaOx) remains virtually unchanged. This signal pattern is unambiguous for tobacco smoke (smoking). The conventional smoke detector SD cannot distinguish from the smoke of a genuine fire here and raises the alarm (A; alarm conventional detector), after passing through several early warning stages VW1, VW2 as of signal value 30.

The time (approx. 4 min. 30 sec.) as of which the conventional smoke detector SD issues an alarm A is shown by the bold dotted vertical arrow line. In the chronological overview on the left of the bold dotted vertical arrow line, no alarm is raised by the gas-sensitive field-effect transistors (No alarm GasFET).

Here the present tobacco smoke detector according to the invention can therefore serve to avoid false alarms.

The analysis of the signal patterns of the gas-sensitive sensor layers is performed advantageously by a microprocessor (chip) established for this purpose in the detector.

Advantageously, the tobacco smoke detector according to the invention is supportively connected to a fire alarm or an alarm control unit.

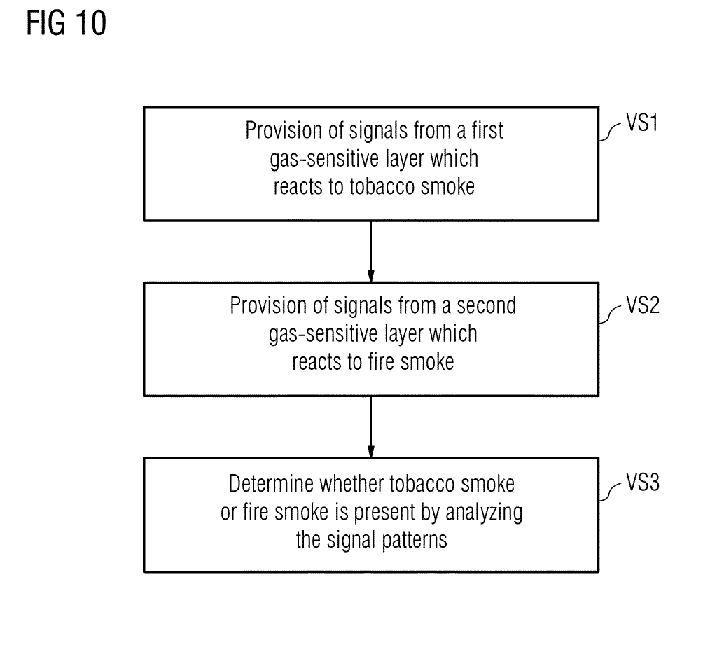

FIG. 10 shows an exemplary flow chart for the method according to the invention for distinguishing between tobacco smoke and fire smoke, wherein signals from a first gas-sensitive coating which reacts to tobacco smoke are recorded (VS1); wherein in addition signals from a second gas-sensitive coating which reacts to fire are recorded (VS2); and wherein based on the signal patterns supplied by the first and the second gas-sensitive coating, it is determined by an evaluation unit whether tobacco smoke and/or fire smoke is present (VS3), wherein the first gas-sensitive coating (e.g. TiN) reacts to ammonia and the second gas-sensitive coating (e.g. CuPC) also reacts to other combustion gas components.

Advantageously the first gas-sensitive coating is formed by a TiN layer and the second gas-sensitive coating by a layer of organic porphin pigments and/or a layer of organic polymers and/or inorganic substances.

Advantageously the inorganic substances contain oxides and/or carbonates and/or phosphates and/or halides and/or metals.

Advantageously the metals contain platinum and/or palladium and/or gold and/or nickel and/or rhodium.

A tobacco smoke detector with a gas-sensitive semiconductor sensor device (in particular, GasFET sensor) with a first gas-sensitive layer which reacts to tobacco smoke and a second gas-sensitive layer which reacts to fire products, and an evaluation unit (e.g. microchip) to analyze the signals supplied by the first and the second gas-sensitive layer and to determine whether tobacco smoke is present. Optionally the tobacco smoke detector contains an interface for connection using signals or data technology to a hazard detector and/or a hazard control unit and/or an output device, in particular for the transmission of information as to whether tobacco smoke is present. Optionally, the tobacco smoke detector can be operatively integrated into a conventional hazard detector (e.g. fire alarm).

The following is a summary list of reference numerals and the corresponding structure used in the above description of the invention.

### LIST OF REFERENCE CHARACTERS

TRM1-TRM3 Tobacco smoke detector
AE1-AE3 Evaluation unit
AV1-AV5,TV,TERM,S Output device
GS1,GS2 Semiconductor sensor device
GSS1,GSS2 Gas-sensitive layer
SS1-SS3 Interface
MS Detector circuit
Z Control center
VENT Ventilation signal
SIG1,SIG2 Signal
ID Identification signal
CIG,CIG′,CIG″ Tobacco smoke signal
FIRE,FIRE′,FIRE″ Fire signal
GH Housing
OF Opening
BM Fire alarm
BMZ Fire alarm control unit
HMS Hotel management system
GMA Hazard detection system
ST Control line
R1-R4 Space
M1-M5 Detectors
VS1-VS3 Method step
A Alarm signal
VW1, VW2 Early warning stages

1. A tobacco smoke detector, comprising:
a gas-sensitive semiconductor sensor device having a first gas-sensitive layer which reacts to tobacco smoke, and a second gas-sensitive layer which reacts to fire products;
an evaluation unit for analyzing signals supplied by said first and second gas-sensitive layers and for determining whether the tobacco smoke is present; and
an interface for connecting to a hazard detector, a hazard control unit and/or an output device via further signals or data technology, including a transmission of information as to whether the tobacco smoke is present.

2. The tobacco smoke detector according to claim 1, wherein said first gas-sensitive layer has a TiN layer, and/or a Pd layer and/or an Rh layer and/or a Pt layer.

3. The tobacco smoke detector according to claim 1, wherein said second gas-sensitive layer has a GaOx layer and/or a CuPC layer.

4. The tobacco smoke detector according to claim 1, wherein said first gas-sensitive layer has a TiN layer and said second gas-sensitive layer has a GaOx layer and/or a CuPC layer and/or a Pd layer and/or an Rh layer and/or a Pt layer.

5. The tobacco smoke detector according to claim 1, further comprising an output unit for an optical output and/or an acoustic output of a smoking ban instruction.

6. The tobacco smoke detector according to claim 1, wherein when the tobacco smoke is detected the tobacco smoke detector takes corresponding ventilation measures in an area of a space in which the tobacco smoke detector is disposed.

7. The tobacco smoke detector according to claim 1, wherein the tobacco smoke detector is integrated into a hazard detector for detection of hazards in a building.

8. A hazard detector for detection of hazardous situations in a building, the hazard detector comprising:
a tobacco smoke detector, containing:
a gas-sensitive semiconductor sensor device having a first gas-sensitive layer which reacts to tobacco smoke, and a second gas-sensitive layer which reacts to fire products;
an evaluation unit for analyzing signals supplied by said first and second gas-sensitive layers and for determining whether the tobacco smoke is present; and
an interface for connecting to a hazard control unit and/or an output device via further signals or data technology, including a transmission of information as to whether the tobacco smoke is present.

9. The hazard detector according to claim 8, wherein the hazard detector is a fire alarm which has an optical measuring chamber.

10. The hazard detector according to claim 8, wherein the hazard detector is a point detector.

11. A hazard detection system, comprising:
an alarm control unit;
a hazard detector;
a detector circuit connected to said alarm control unit and said hazard detector;
at least one tobacco smoke detector connected to said detector circuit, said at least one tobacco smoke detector, containing:
a gas-sensitive semiconductor sensor device having a first gas-sensitive layer which reacts to tobacco smoke, and a second gas-sensitive layer which reacts to fire products;
an evaluation unit for analyzing signals supplied by said first and second gas-sensitive layers and for determining whether the tobacco smoke is present; and
an interface connected to said hazard detector and said alarm control unit via further signals or data technology, including a transmission of information as to whether the tobacco smoke is present; and
a control unit connected to said at least one tobacco smoke detector, said control unit being equipped to analyze the signals from said at least one tobacco smoke detector and, based on the signals, to initiate appropriate measures in an area of a space in which said at least one tobacco smoke detector issuing a signal is disposed.

12. The hazard detection system according to claim 11, wherein communication between said hazard detector and said alarm control unit and communication between said tobacco smoke detector and said control unit takes place in different time slots.

13. The hazard detection system according to claim 11, wherein means for optional switching of said detector circuit is provided on one of said alarm control unit and said control unit.

14. The hazard detection system according to claim 11, further comprising means for prioritizing messages from said hazard detector and for suppressing a switching of said detector circuit to said control unit.

15. The hazard detection system according to claim 11, wherein said control unit is a hotel management system.

16. The hazard detection system according to claim 11, wherein said hazard detector is a fire alarm.

17. A method for distinguishing tobacco smoke and fire smoke, which comprises the steps of:
recording signals from a first gas-sensitive coating which reacts to tobacco smoke, the first gas-sensitive coating reacting to ammonia;
recording additional signals from a second gas-sensitive coating which reacts to fire, the second gas-sensitive coating further reacts to other combustion gas components; and
determining, via an evaluation unit, whether the tobacco smoke and/or the fire smoke is present, based on signal patterns supplied by the first and the second gas-sensitive coatings.

18. The method according to claim 17, which further comprises:
providing the first gas-sensitive coating with a TiN layer;
providing the second gas-sensitive coating with a layer of organic porphin pigments and/or a layer of organic polymers and/or inorganic substances.

19. The method according to claim 18, wherein the inorganic substances are selected from the group consisting of oxides, carbonates, phosphates, halides and metals.

20. The method according to claim 19, wherein the metals are selected from the group consisting of platinum, palladium, gold, nickel and rhodium.
